(19) United States
(12) Patent Application Publication
(10) Pub. No.: US 2009/0300726 A1
(43) Pub. Date: Dec. 3, 2009

(54) ETHERNET SERVICE CAPABILITY NEGOTIATION AND AUTHORIZATION METHOD AND SYSTEM

(75) Inventors: Nanjian QIAN, San Diego, CA (US); Cancan HUANG, Plano, TX (US); Yingzhe WU, San Marcos, CA (US)

Correspondence Address: MORRISON & FOERSTER LLP, 12531 HIGH BLUFF DRIVE, SUITE 100, SAN DIEGO, CA, 92130-2040, US

(73) Assignee: ZTE (USA), INC., SAN DIEGO, CA (US)

(21) Appl. No.: 12/475,400

(22) Filed: May 29, 2009

Related U.S. Application Data
(60) Provisional application No. 61/057,766, filed on May 30, 2008.
(60) Provisional application No. 61/085,362, filed on Jul. 31, 2008.

(51) Int. Cl. G06F 15/16

(52) U.S. Cl. 726/4

(57) ABSTRACT

Described herein are methods and systems for negotiating and authorizing one or more Ethernet and/or IP services among a plurality of network entities in a wireless communication system. In one embodiment, an Access Service Network Entity transmits Ethernet Service capability data to a Home Connectivity Service Entity. Optionally, the Ethernet Service capability data may include Ethernet Service capability data associated with a Visited Connectivity Service Entity. The Home Connectivity Service Entity then determines which Ethernet and/or IP Services are authorized for a particular mobile station associated with the Access Service Network Entity based upon the received Ethernet Service capability data, a subscriber profile, and a home network policy.

### CROSS-REFERENCE TO RELATED APPLICATIONS

This application claims priority to U.S. Provisional Patent Application No. 61/057,766, filed on May 30, 2008, and U.S. Provisional Patent Application No. 61/085,362, filed on Jul. 31, 2008, the contents of which are incorporated by reference herein in their entirety.

### FIELD OF THE INVENTION

The present invention relates generally to wireless communication networks, and more particularly, to a method and system for Ethernet service negotiation and authorization among various network entities.

### BACKGROUND OF THE INVENTION

With the increasing popularity of mobile devices, there exists a need to allow users to attach to various domains, depending on their current location. A user may require access to resources being provided by a visited network different than their home network. The need for service from a visited network requires, in many models, negotiation and authorization between the mobile device and the visited network.

More specifically, there is presently a need in the art to provide a method and system for Ethernet service capability negotiation and authorization among different network entities. In addition, there is a need to leverage the network access authentication and authorization process to negotiate the appropriate Ethernet service among various network entities using remote authentication protocols.

### SUMMARY OF THE INVENTION

The presently disclosed embodiments are directed to solving one or more of the problems presented in the prior art, described above, as well as providing additional features that will become readily apparent by reference to the following detailed description when taken in conjunction with the accompanying drawings.

One exemplary aspect of the present invention is directed to a method of negotiating and authorizing one or more Ethernet services among a plurality of network entities in a wireless communication system. In one embodiment, the method includes: transmitting a first signal from a first network device to a second network device, the first signal adapted to indicate Ethernet service capability data associated with the first network device; receiving at the first network device a second signal from the second network device, the second signal adapted to indicate a set of authorized Ethernet services for a mobile station adapted for communication with the first network device; and storing data at the first network device, wherein the data is adapted to indicate the set of authorized Ethernet services for the mobile station.

In a second embodiment, the method includes: receiving at a second network device a first signal from a first network device, the first signal adapted to indicate Ethernet service capability data associated with the first network device; determining a set of authorized Ethernet services for a mobile station adapted for communication with the first network device based at least in part upon the Ethernet service capability data; and transmitting a second signal from the second network device to the first network device, the second signal adapted to indicate the set of authorized Ethernet services for the mobile station.

In a third embodiment, the method includes: receiving at an intermediary network device a set of capability data, the set of capability data adapted to indicate Ethernet capability data associated with a first network device; appending Ethernet capability data associated with the intermediary network device to the set of capability data; transmitting the set of capability data to a second network device, the second network device adapted to generate a set of authorization data for indicating a set of authorized Ethernet services for a mobile station in communication with the first network device, wherein the set of authorization data is based at least in part upon the set of capability data; receiving at the intermediary network device the set of authorization data; and transmitting the set of authorization data to the first network device, wherein the first network device is adapted to provide Ethernet service to the mobile station based at least in part upon the set of authorization data.

Thus, embodiments disclosed herein provide a method and system for Ethernet service capability negotiation and authorization among different network entities. It is to be understood that both the foregoing general description and the following detailed description are exemplary and are merely intended to provide further explanation of the claimed subject matter.

### BRIEF DESCRIPTION OF THE DRAWINGS

The features, nature and advantages of the present disclosure will become more apparent from the detailed description set forth below when taken in conjunction with the drawings in which like reference characters identify correspondingly throughout and wherein:

FIG. 1 is a block diagram illustrating an exemplary architecture of a wireless communication system according to one embodiment of the present invention.

FIG. 2 is a block diagram illustrating an exemplary mobile station in a wireless communication network according to one embodiment of the present invention.

FIG. 3 is a block diagram illustrating an exemplary access service network according to one embodiment of the present invention.

FIG. 4 is a block diagram illustrating an exemplary connectivity service network according to one embodiment of the present invention.

FIG. 5 is a sequence diagram illustrating an exemplary method of Ethernet and IP service negotiation according to one embodiment of the present invention.

FIG. 6 is a flow diagram illustrating an exemplary method of negotiating and authorizing one or more Ethernet services among a plurality of network entities in a wireless communication system according to one embodiment of the present invention.

FIG. 7 is a flow diagram illustrating an exemplary method of negotiating and authorizing one or more Ethernet services among a plurality of network entities in a wireless communication system according to one embodiment of the present invention.

FIG. 8 is a flow diagram illustrating an exemplary method of negotiating and authorizing one or more Ethernet services among a plurality of network entities in a wireless communication system according to one embodiment of the present invention.

FIG. 9 is a diagram of an exemplary RADIUS message for indicating WiMAX capability according to one embodiment of the present invention.

FIG. 10 is a diagram of an exemplary RADIUS TLV definition for indicating various ASN and V-CSN service capabilities according to one embodiment of the present invention.

FIG. 11 is a diagram of an exemplary RADIUS message providing the IPv4 address of the V-CSN HA for MIP4 according to one embodiment of the present invention.

FIG. 12 is a diagram of an exemplary RADIUS message providing the IPv6 address of the HA used for MIP6 according to one embodiment of the present invention.

FIG. 13 is a diagram of an exemplary RADIUS message providing the IPv4 address of the V-CSN DHCP-Server to use for IPv4 address allocation according to one embodiment of the present invention.

FIG. 14 is a diagram of an exemplary RADIUS message providing the IPv6 address of the V-CSN DHCP-Server to use for IPv6 address allocation according to one embodiment of the present invention.

FIG. 15 is a diagram of an exemplary RADIUS message providing the IPv4 address of the V-CSN LMA to use for IPv4 address allocation according to one embodiment of the present invention.

FIG. 16 is a diagram of an exemplary RADIUS message providing the IPv4 address of the H-CSN LMA to use for IPv4 address allocation according to one embodiment of the present invention.

FIG. 17 is a diagram of an exemplary RADIUS message providing the IPv4 address of the V-CSN LMA to use for IPv6 address allocation according to one embodiment of the present invention.

FIG. 18 is a diagram of an exemplary RADIUS message providing the IPv4 address of the H-CSN LMA to use for IPv6 address allocation according to one embodiment of the present invention.

FIG. 19 is a diagram of an exemplary RADIUS message providing the IPv4 address of the V-CSN CR to use for IPv4 address allocation according to one embodiment of the present invention.

FIG. 20 is a diagram of an exemplary RADIUS message providing the IPv4 address of the H-CSN CR to use for IPv4 address allocation according to one embodiment of the present invention.

FIG. 21 is a diagram of an exemplary RADIUS message providing the IPv4 address of the V-CSN CR to use for IPv6 address allocation according to one embodiment of the present invention.

FIG. 22 is a diagram of an exemplary RADIUS message providing the IPv4 address of the H-CSN CR to use for IPv6 address allocation according to one embodiment of the present invention.

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

As used herein, the term “access service network” (ASN) includes without limitation any set of network functions that provide radio access to a mobile station.

As used herein, the term “base station” (BS) includes, without limitation, a generalized equipment set providing connectivity, management, and control of a subscriber station (MSS).

As used herein, the term “connectivity service network” (CSN) includes without limitation any set of network functions that provide IP connectivity services to a mobile station which has IP connectivity capability.

As used herein, the term “mobile station” (MS) includes without limitation a station with mobile service intended to be used while in motion or during halts at unspecified points.

As used herein, the term “reference point” (RP) includes without limitation a conceptual link that connects two groups of functions which reside in different functional entities of an ASN, CSN, or MSS. Note that a “reference point” is not necessarily required to be a physical interface.

As used herein, the term “reference point R3” includes without limitation a set of control plane protocols between an ASN and a CSN to support Authentication, Authorization, and Accounting (AAA), policy enforcement, and mobility management capabilities. It also may encompass the bearer plane methods (e.g., tunneling) to transfer IP data between an ASN and a CSN.

As used herein, the term “home agent” (HA) includes without limitation a router on a mobile node's home network which tunnels a datagram for delivery to the mobile node when it is away from home. It also may maintain current location information for the mobile node.

As used herein, the term “Ethernet Service Home Agent” (eHA) includes without limitation a module with the regular functionality of a home agent as well as bridge functionality. This module can therefore forward, anchor, classify and tunnel pure Ethernet frames instead of IP packets.

As used herein, the term “foreign agent” (FA) includes without limitation a router on a visited network which may tunnel/de-tunnel a datagram for delivery to the mobile node when it is away from home. The foreign agent may also maintain tunneling information for the mobile node.

As used herein, the term “Ethernet Service Foreign Agent” (eFA) includes without limitation a module with the regular functionality of a foreign agent as well as the capability to receive, classify, and tunnel pure Ethernet frames instead of IP packets.

As used herein, the term “local mobility anchor” (LMA) includes without limitation a home agent for a mobile node in the Proxy Mobile IPv6 domain. The local mobility anchor may serve as the topological anchor point for the mobile node's home prefix and manage the mobile node's reachability state.

As used herein, the term “mobile access gateway” (MAG) includes without limitation an entity where the proxy mobile agent function resides.

As used herein, the term “Simple Ethernet Service” includes without limitation a service which uses non-MIP based functional entities (i.e., an Ethernet bridge in a CSN) to provide Ethernet service through a WiMAX network. The bridge attached to the CSN may provide a dedicated bridge port for each of the mobile stations anchored at the CSN.

As used herein, the term “MIP-based Ethernet Service” includes without limitation a service which deploys Mobile IP to provide a dynamic tunnel setup on RD so as to realize wide area roaming and mobility for Ethernet-CS-based terminals. Due to its dynamic behavior, the R3 interface may be fully defined for MIP-based Ethernet Services.

As used herein, the term “WiMAX network” includes without limitation a network architecture based on the IEEE 802.16 d/e wireless standard.

As used herein, the term “access router” (AR) includes without limitation a first hop router located within an ASN that is used to provide Simple IP traffic routing services.

As used herein, the term “Ethernet Service Access Forwarding Function” (eAFF) includes without limitation a first hop forwarding function location in an ASN that is used for Simple Ethernet Service traffic Forwarding. The eAFF could be used within a router to tunnel a pure Ethernet frame to the other end of a tunneling point.

As used herein, the term “core router” (CR) includes without limitation a connection router located within a CSN that is used for Simple IP traffic routing. A core router may be the counterpart of an access router.

As used herein, the term “Ethernet Service Core Forwarding Function” (eCFF) includes without limitation an Ethernet packet forwarding function that is located in a CSN and used for Simple Ethernet Service traffic. The eCFF may be the counterpart of an eAFF. It may also refer to a bridge function.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

A WiMAX network can provide IP and Ethernet Services to an end user based on service provider business requirements, subscriber profiles, network architecture and network entity capability information. As will be described in more detail below, in order to provide a successful user service session, several major network entities may be involved, including, for example, an access service network (ASN), a home connectivity service network (H-CSN), and/or a visited connectivity service network (V-CSN). Each network entity may be capable of providing multiple Ethernet and IP services. Capabilities that may be associated with an ASN may include, for example, DHCPv4 Relay, DHCPv6 Relay, DHCPv4 Proxy, DHCPv6 Proxy, FA, PMIP Client, AR with IPv4 transport, AR with IPv6 transport, eAFF with IPv4 transport, and eAFF with iPv6 transport. Capabilities that may be associated with a V-CSN may include, for example, v-DHCPv4 Server, v-DHCPv6 Server, MIP-HAv4, MIP-HAv6, MIP-eHAv4, and MIP-eHAv6. Since each network entity may have different Ethernet Service and IP service capabilities, various embodiments of the present invention are directed to a novel method of service capability negotiation and authorization among the various network entities.

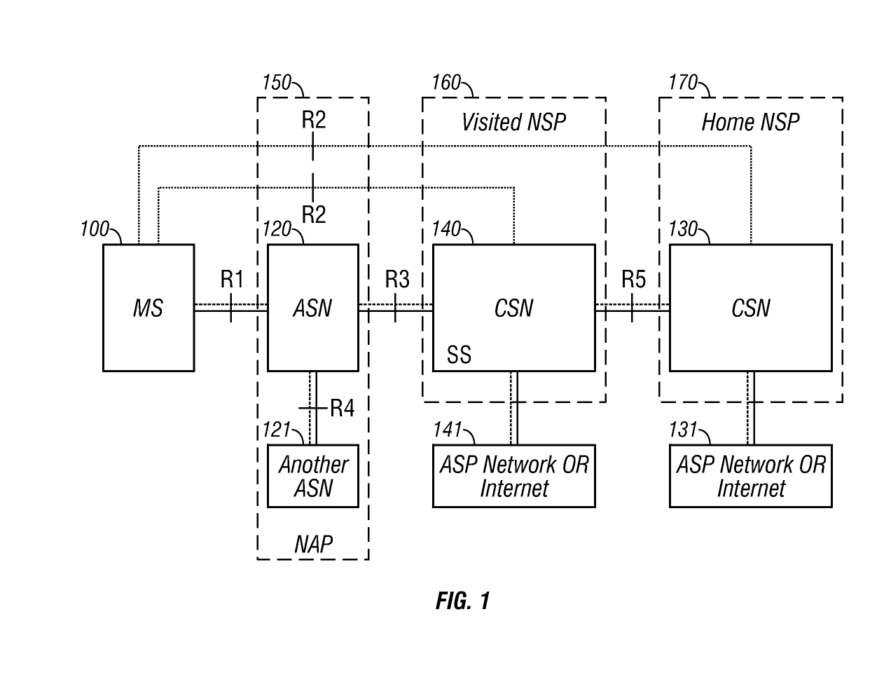

FIG. 1 is an illustration of an exemplary architecture of a wireless communication system according to one embodiment of the present invention. The wireless communication network may be a WiMAX network that complies with the Institute of Electrical and Electronics Engineers (IEEE) 802.16 communication system protocol. However, the present invention is not limited to any particular network type, and various network technologies performing service capability negotiation may be implemented without departing from the scope of the present disclosure.

According to the embodiment depicted in FIG. 1, a wireless communication network includes a mobile station 100. An ASN 120 associated with a network access provider (NAP) 150 may provide a set of network functions that support radio access to mobile station 100. Thus, when the mobile station 100 is in close proximity to an ASN 120, the mobile station 110 may attempt to acquire Ethernet and/or IP services from the ASN 120.

In some embodiments, the ASN 120 can negotiate and determine which Ethernet and/or IP services will be provided to mobile station 100 after such services have been authorized by the H-CSN 130. The wireless communication network of FIG. 1 may also include a V-CSN 140, which may act as a proxy to the H-CSN 130. That is, the ASN 120 may transfer IP data to H-CSN 130 by “tunneling” through V-CSN 140 using connections R3 and R5. Note that for the purposes of this example, the V-CSN 140 and the H-CSN may exist within visited network service provider (NSP) 160 and home NSP 170, respectively. Additionally, both the V-CSN 140 and the H-CSN 130 may be capable of providing access to respective application service provider (ASP) networks or the Internet 141 and 131.

As shown in FIG. 1, the link R2 illustrates a reference point between the mobile station 100 and connectivity service network entities (V-CSN 140 and H-CSN 130). To implement this network configuration, the mobile station 100 may be physically connected to the ASN 120 by a hard-wire or wireless connection. This is shown as connection R1. The ASN 120 itself may be connected wirelessly or otherwise to one or more other ASNs 121 via connection R4. Note, however, that the architectural arrangement depicted in FIG. 1 is merely illustrative in nature; various other network entities and combinations thereof may be included without departing from the scope of the present invention.

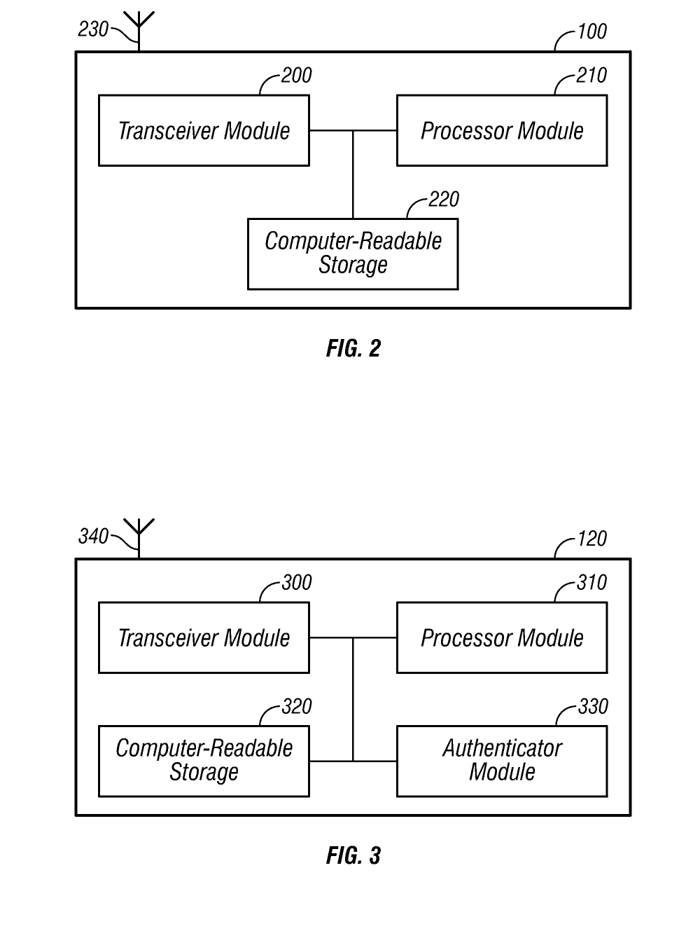

FIG. 2 is an illustration of an exemplary mobile station 100 in a wireless communication network according to one embodiment of the present invention. In an exemplary embodiment, the mobile station 100 may be a user device such as a mobile phone. Alternately, mobile station 100 may be a personal digital assistant (PDA) such as a Blackberry device, MP3 player or other similar portable device. According to still other embodiments, the mobile station 100 may be a personal wireless computer such as a wireless notebook computer or a wireless palmtop computer.

As shown in FIG. 2, the exemplary mobile station 100 may include a transceiver module 200 configured to support alternate or additional wireless data communication protocols. These protocols include, without limitation, future variations of IEEE 802.16 (such as 802.16e, 802.16m, etc).

The transceiver module 200 may generally enable bi-directional communication between mobile station 100 and various network entities via antenna 230. Note that the transceiver module 200 may be configured to support internet or WiMAX traffic as well as to provide an 802.3 Ethernet interface.

In some embodiments, the mobile station 100 comprises a processor module 210 that is configured to carry out the functions, techniques, and processing tasks associated with the operation of mobile station 100. The processor module 210 may include any number of devices or device combinations as known in the art. These include, for example, general purpose processors, content addressable memory modules, digital signal processors, application-specific integrated circuits, field programmable gate arrays, programmable logic arrays, discrete gate or transistor logic, or other such electronic components.

Furthermore, the steps of a method or algorithm described in connection with the embodiments disclosed herein may be embodied directly in hardware, in firmware, in a software module executed by processor module 210, or in any practical combination thereof. A software module may reside in computer-readable storage 220, which may be realized as RAM memory, flash memory, ROM memory, EPROM memory, EEPROM memory, registers, a hard disk, a removable disk, a CD-ROM, or any other form of storage medium known in the art. In this regard, computer-readable storage 220 may be coupled to processor module 210 so that processor module 210 can read information from, and write information to, the computer-readable storage 220. In some embodiments, the computer-readable storage 220 includes cache memory for storing temporary variables or other intermediate information during execution of instructions by the processor module 210. In some embodiments, the computer-readable storage 220 also includes non-volatile memory.

The computer-readable storage 220 may also include a frame structure database (not shown) in accordance with some embodiments of the present invention. This frame structure database may be configured to store, maintain, and provide data as needed to support the functionality of a wireless communication system. Additionally, the frame structure database may include a lookup table for purposes of storing frame structure parameters. Note that the frame structure database may consist of either a local database (e.g., coupled to the processor module 210), or a remote database (e.g., a central network database).

FIG. 3 is an illustration of an exemplary ASN 120 according to one embodiment of the present invention. The ASN 120 may include a transceiver module 300 coupled to an antenna 340, a processor module 310, and computer-readable storage 320. The transceiver module 300, the processor module 310, and the computer-readable storage 320 may be configured similarly to the transceiver module 200, the processor module 210 and computer-readable storage 220 as described above with reference to FIG. 2. The ASN 120 may additionally include an authenticator module 330 for transmitting service capability data associated with the ASN 120 to a remote module via transceiver module 300. This service capability data may be used by the H-CSN 130 to determine a set of Ethernet and/or IP services authorized for the mobile station 100.

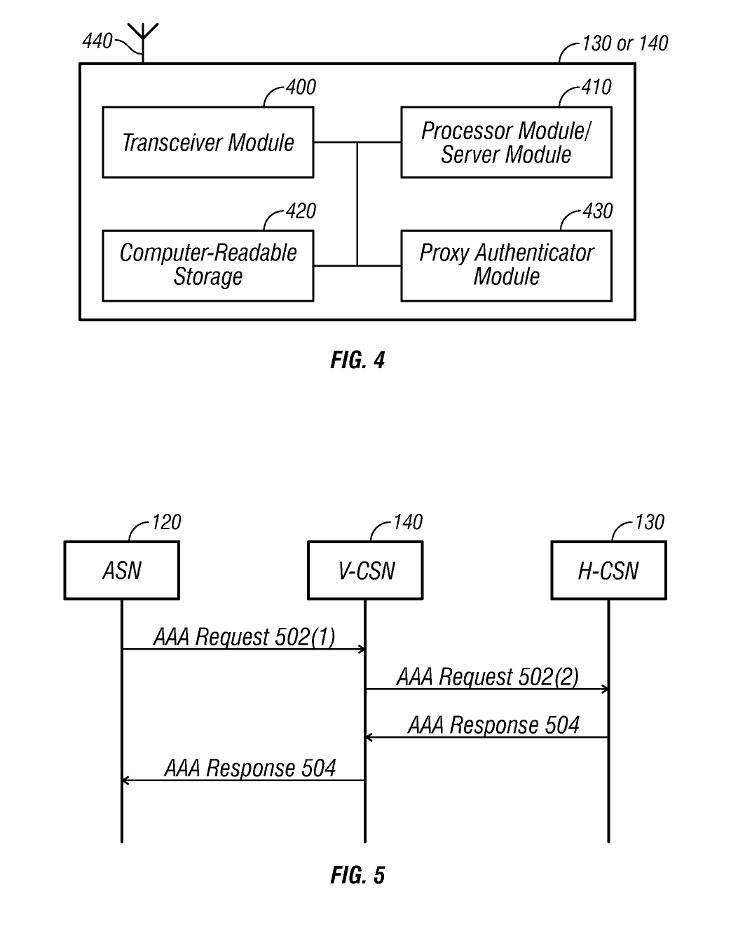

FIG. 4 is an illustration of an exemplary CSN (e.g., a H-CSN 130 or a V-CSN 140) according to one embodiment of the present invention. The CSN 130 or 140 may include a transceiver module 400 communicatively coupled to antenna 440, as well as a computer-readable storage 420 with functionality similar to the transceiver module 200 and the computer-readable storage 220 as described with reference to FIG. 2. The CSN 130 or 140 may additionally include a processor module/server module 410 which may serve as an Authentication, Authorization and Accounting (AAA) processor in an H-CSN 130. Note that the processor module/server module 410 may be implemented similarly to processor module 210 described above with reference to FIG. 2.

If the CSN comprises a V-CSN 140, a proxy authenticator module 430 may also be included. In one embodiment, the proxy authenticator module 430 is adapted to transmit ASN 120 service capability data and V-CSN 140 service capability data to the H-CSN 130. The H-CSN may then transmit authorization data to the V-CSN proxy authenticator module upon determining a set of authorized Ethernet and/or IP services for the mobile station 100. This data may then be forwarded by the proxy authenticator module 430 to the ASN 120 for local storage.

Of course, one of ordinary skill in the art would realize that the above-described mobile station 100, the above described ASN 120, and the above described CSN 130 and 140 are merely exemplary in nature. Various other components and component combinations may also be utilized without departing from the scope of the present disclosure.

FIG. 5 is a sequence diagram illustrating an exemplary method of Ethernet and IP service negotiation according to one embodiment of the present invention. This sequence may occur after the mobile station 100 seeks Ethernet and/or IP services from the ASN 20.

As shown in FIG. 5, an AAA Request 502(1) is initially sent by the ASN 120 to an H-AAA server (not shown) disposed within the H-CSN 130. According to some embodiments, the AAA request 502(1) will include ASN Ethernet Service Capability data as well as ASN IP Access Capability data associated with the ASN 120.

If a V-CSN 140 is serving as a proxy for the H-AAA server, the AAA request 502(1) may instead be sent to the V-CSN 140 instead of directly to the H-CSN 130. In some embodiments, after the V-CSN 140 receives the AAA Request Message 502(1) from the ASN 120, the V-CSN may add V-CSN Ethernet Service Capability data and V-CSN IP Access Capability to this data. The resulting AAA Request 502(2) may then be forwarded to the H-CSN 130.

The H-AAA server may then authenticate and authorize a set of Ethernet and/or IP Services for the mobile station 100 based upon a home network policy, a subscriber profile associated with the mobile station 100, and the capability data contained within the AAA Request 502. Then, once the H-AAA Server has successfully authenticated and authorized a set of services for the mobile station 100, the H-AAA server may return an AAA Response 504 to the ASN 120. Note that the AAA Response may be routed through the V-CSN 140 if the V-CSN 140 is serving as a proxy for the H-AAA server.

The ASN 120 may then extract out Authorized Ethernet and/or IP Services for the mobile station 100. This information may be stored locally and made available to use by appropriate Ethernet Service and IP service functional entities within the ASN 120. Depending on the outcome of the authentication and authorization process, the ASN 120 may then offer Ethernet and/or IP Services to the mobile station 100 (including, for example, Simple Ethernet Service, MIP-based Ethernet Service, Simple IP, PMIP, or CMIP service.

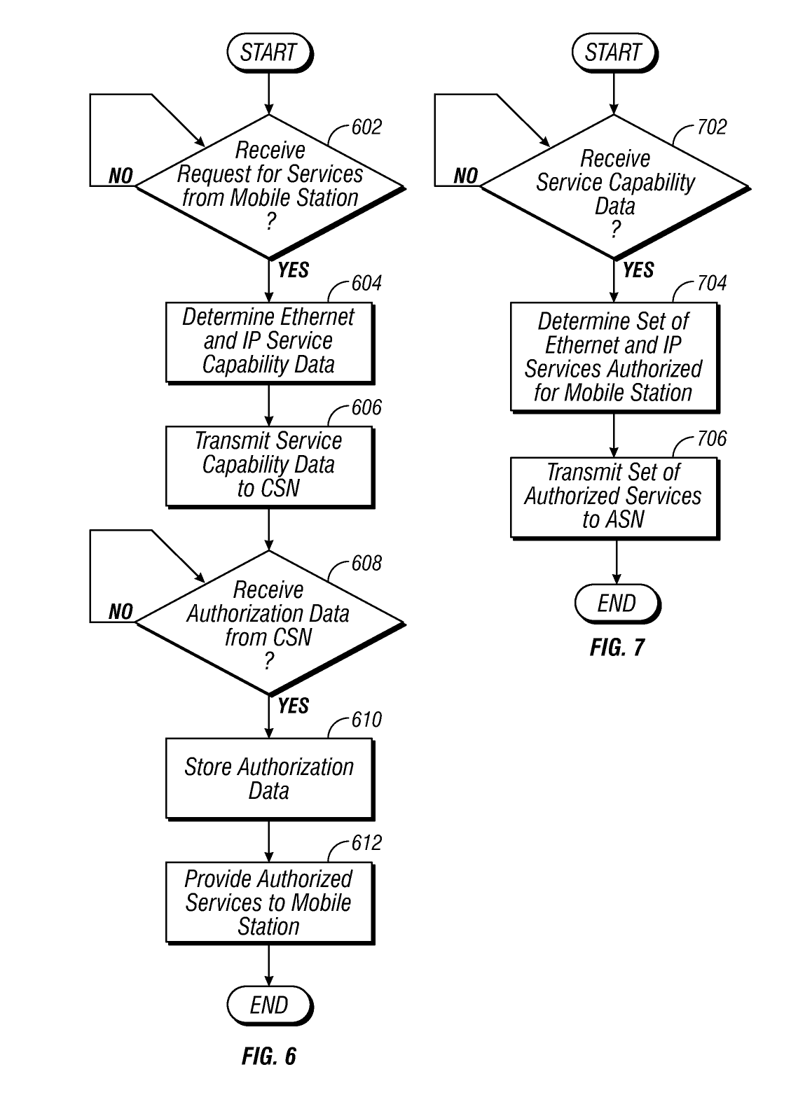

FIG. 6 is a flow diagram illustrating an exemplary method of negotiating and authorizing one or more Ethernet services among a plurality of network entities in a wireless communication system according to one embodiment of the present invention. The method may be used, for example, to enable an ASN 120 to provide a set of authorized services to a requesting mobile station 100.

At block 602, a request for services is initially received from a mobile station 100. The Ethernet and IP services capable of being provided to the mobile station 100 are then determined at block 604 (note that although FIG. 6 describes generally a process for handling requests for Ethernet and/or IP related services, it should be understood that the present invention is not strictly limited to Ethernet and/or IP related services, and may be readily extended to apply to other services as well).

At block 606, the service capability data is transmitted to a CSN (e.g., a V-CSN 140 or an H-CSN 130). In some embodiments, the service capability data is transmitted as an AAA Request 502 which includes four Remote Authentication Dial-In User Service (RADIUS) attributes: (i) ASN Ethernet Service Capability; (ii) ASN IP Service Capability; (iii) V-CSN Ethernet Service Capability; and (iv) V-CSN IP Service Capability. In this manner, an ASN 120 may define the first two attributes, namely: (i) ASN Ethernet Service Capability and (ii) ASN IP Service Capability, while a V-CSN defines the last two attributes: (iii) V-CSN Ethernet Service Capability and (iv) V-CSN IP Service Capability. Note that in some embodiments, a different AAA protocol may be used in the alternative (e.g., a DIAMETER protocol).

After it has been determined that authorization data has been received from a CSN (block 608), the authorization data may be stored at block 610. In some embodiments the data may be stored locally, for example, within a network access server (NAS) disposed within the ASN 120. In other embodiments, the data may be stored remotely and accessed locally. The data may then be made available to Ethernet and/or IP Service functional entities within the ASN 120. At step 612, the mobile station request may then be processed based upon a determination as to whether the services requested have been authorized.

An exemplary set of rules governing behavior of the NAS in a WiMAX environment is now described. Note that the following rules are only illustrative of one particular embodiment of the present invention. It should be understood, however, that myriad other rules and device behaviors may be defined so as to enable Ethernet and IP Service Capability Negotiation according to the scope of the present invention.

Thus, in one embodiment, the NAS shall include ASN Ethernet Service and IP Service Capability attributes within the WiMAX Capability VSA in the AAA authentication Request message 502 and forward this message 502 toward the H-AAA in the H-CSN 130 through an AAA-Proxy in a V-CSN 140 (if a V-CSN 140 is being utilized). The capability information may be carried by different bits in one type, length, value (TLV) or by different TLVs. If the NAS receives the Authorized Ethernet Service and IP Service attribute within the WiMAX Capability VSA of the AAA authentication response message 504, the NAS shall store this information locally and use this as an indication of which Ethernet and/or IP services have been authorized for the mobile station 100. If the NAS receives an AAA authentication response message 504 which requires the ASN 120 to provide an Ethernet or IP service that it cannot support, then the NAS shall treat the AAA authentication response message 504 as an Access Reject.

If the NAS receives Simple IPv4 authorization through the Authorized IP/Ethernet Service attribute in the RADIUS Access-Accepts WiMAX capability VSA, the NAS shall store this information locally and make it available to be used later for Simple IPv4 service anchored according to the Authorized Anchor Location sub-TLV. If the NAS receives a Simple IPv6 authorization through the Authorized IP/Ethernet Service attribute in the RADIUS Access-Accepts WiMAX capability VSA, the NAS shall store this information locally and make it available to be used later for Simple IPv6 service anchored according to the Authorized Anchor Location sub-TLV. If the NAS receives Simple Ethernet Service authorization through the Authorized IP/Ethernet Service attribute in the AAA authentication response message WiMAX capability VSA, the NAS shall store this information locally and make it available to be used later for Simple Ethernet service anchored according to the Authorized Anchor Location sub-TLV.

If the NAS receives either vHA-IP-MIP4 or hHA-IP-MIP4 attributes in the AAA authentication response message 504, the NAS shall store these HAv4 attributes locally and make them available to be used later for either CMIPv4, PMIPv4, or MIP-based Ethernet services to the mobile station 100. If the NAS receivers either vHA-IP-MIP6 and/or hHA-IP-MIP6 attributes in the AAA authentication response message, the NAS shall store these HAv6 attributes locally and make them available to be used later for CMIPv6 services to the mobiles station 100.

If the NAS receives either vDHCP or hDHCP Server attributes in the AAA authentication response message 504, the NAS shall store these attributes locally and make them available to be used in a subsequent DHCP signaling transaction. These attributes may also indicate that DHCP Relay functionality is enabled for the mobile station 100. If the NAS does not receive DHCP Server attributes in the AAA authentication response message, this indicates that DHCP Proxy functionality is enabled for the mobile station 100. The NAS may then store the IP and Host configuration attributes locally and make them available for use in a subsequent DHCP signaling transaction. These attributes may also indicate that DHCP proxy functionality is enabled for the mobile station 100.

If the NAS receives either vLMA or hLMA attributes in the AAA authentication response message 504, the NAS shall store these attributes locally and make them available to be used in subsequent PMIPv6 services or MIP Ethernet Service for the mobile station 100. If the NAS receives vCR, hCR, veCFF, or heCFF attributes within an AAA authentication response message 504, the NAS shall store these attributes locally and make them available to be used in subsequent Simple IPv4, Simple IPv6, or Simple Ethernet Service for the mobile station 100.

Finally, if the NAS receives DHCP Server attributes in the AAA authentication response message 504, the NAS shall store these attributes locally and make them available to be used in a subsequent DHCP signaling transaction. These attributes may indicate that DHCP Relay functionality is enabled for the mobile station 100. If the NAS does not receive DHCP Server attributes in the AAA authentication response message 504, this may indicate that DHCP Proxy functionality is enabled for the mobile station 100.

FIG. 7 is a flow diagram illustrating an exemplary method of negotiating and authorizing one or more Ethernet services among a plurality of network entities in a wireless communication system according to one embodiment of the present invention. The method may be used, for example, to enable an H-CSN 130 to transmit a set of Ethernet and/or IP services authorized for a mobile station 100.

At block 702, service capability data is received. In some embodiments, the service capability data includes a set of four attributes: (i) ASN Ethernet Service Capability; (ii) ASN IP Service Capability; (iii) V-CSN Ethernet Service Capability; and (iv) V-CSN IP Service Capability. The data may be contained within an AAA authorization request message 502 that is governed by an AAA protocol (e.g., RADIUS, DIAMETER, etc.), or it may take on another format according to embodiments of the present invention.

At block 704, a set of Ethernet and IP services authorized for the requesting mobile station 100 is then determined. The set of authorized services may be based upon a subscriber profile associated with the mobile station 100, a home network policy, the received service capability data, or any combination thereof.

At block 706, the set of authorized services is then transmitted to the ASN 706. The set of authorized services may be contained within an AAA authorization response message 504 that is governed by an AAA protocol (e.g., RADIUS, DIAMETER, etc.), or it may take on another format according to embodiments of the present invention. Note that if a V-CSN 140 is serving as a proxy for an H-AAA server, the message may be transmitted to the V-CSN 140 before being forwarded on to the ASN 120.

An exemplary set of rules governing behavior of the H-CSN 140 and a corresponding H-AAA is now described. Note that the following rules are only illustrative of one particular embodiment of the present invention. It should be understood, however, that myriad other rules and device behaviors may be defined so as to enable Ethernet and IP Service Capability Negotiation according to the scope of the present invention.

In one embodiment, if the H-CSN 130 receives an AAA authentication request message, the H-CSN 130 shall authorize the appropriate Ethernet and IP Services for a given mobile station 100 based on the subscriber profile associated with the mobile station 100, a home network policy, and the received service capability data (e.g., ASN IP Service capability, ASN Ethernet Service capability, V-CSN IP Service capability, and V-CSN Ethernet Service Capability). The H-AAA in the H-CSN 130 shall send an AAA authentication response message towards the NAS in the ASN 130 (note that the AAA authentication response message will pass through a V-CSN 140 in the case where the mobile station 100 is roaming).

In one embodiment, the H-AAA shall include Authorized IP and Ethernet Service attributes to indicate the IP/Ethernet services for which the mobile station 100 is authorized. The H-AAA shall not authorize an IP or Ethernet Service which cannot be supported by both the H-CSN 130 and the ASN 120.

If the H-AAA has authorized CMIPv4 or PMIPv4 service, the HAAA shall include vHA-IP-MIP4 or hHA-IP-MIP4 attributes within the AAA authentication response message 504. If the H-AAA has authorized MIP Ethernet Service, the H-AAA shall include vHA-IP-MIP4, hHA-IP-MIP4, vHA-IP-MIP6, or hHA-IP-MIP6 attributes in the AAA authentication response message 504. If the H-AAA has authorized CMIPv6 service, the H-AAA shall include vHA-IP-MIP6 or hHA-IP-MIP6 attributes in the AAA authentication response message 504.

If the H-AAA includes V-CSN 140 or H-CSN 130 DHCP Server attributes, the H-AAA shall indicate that it has authorized use of DHCP Relay functionality within the ASN 120. The H-AAA should authorize DHCP Proxy functionality only if the ASN 120 previously indicated corresponding support. However, if the H-AAA does not include V-CSN 140 or H-CSN 130 DHCP Server attributes, the H-AAA shall indicate authorized use of DHCP Proxy functionality in the ASN 120. The H-AAA should authorize DHCP Proxy functionality only if the ASN previously indicated corresponding support.

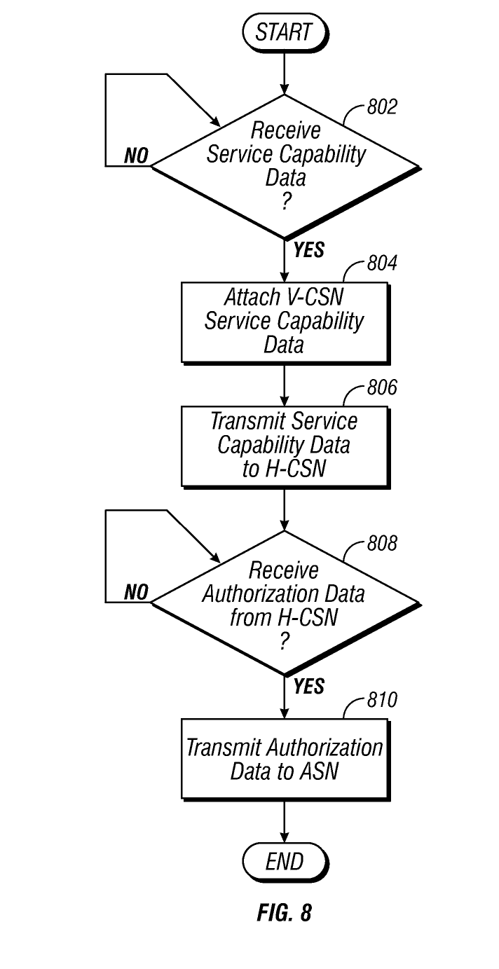

FIG. 8 is a flow diagram illustrating an exemplary method of negotiating and authorizing one or more Ethernet services among a plurality of network entities in a wireless communication system according to one embodiment of the present invention. The method may be used, for example, to enable a V-CSN 140 to provide a set of authorized services to a requesting mobile station 100.

At block 802, service capability data is received from an ASN 120. The service capability data may be contained within an AAA authorization request message 502 that is governed by an AAA protocol (e.g., RADIUS, DIAMETER, etc.), or it may take on another format according to embodiments of the present invention. In some embodiments, the service capability data contains four attributes: (i) ASN Ethernet Service Capability; (ii) ASN IP Service Capability; (iii) V-CSN Ethernet Service Capability; and (iv) V-CSN IP Service Capability. Thus, capabilities associated with the ASN 120 may be provided by the first two attributes, while capabilities associated with the V-CSN 140 may be added to the last two attributes. The process of attaching V-CSN services to the service capability data is shown at block 804.

At block 806, service capability data is transmitted to the H-CSN 130. The H-CSN 130 may then calculate a set of authorized services for the mobile station 100 based at least in part upon the service capability data. Once the authorization data has been received from the H-CSN 130 at block 808, this data may then be transmitted to the ASN 120 at block 810. The ASN 120 may then provide only those services to the mobile station 100 that have been indicated as authorized.

An exemplary set of rules governing behavior of the V-CSN 140 is now described. Note that the following rules are only illustrative of one particular embodiment of the present invention. It should be understood, however, that myriad other rules and device behaviors may be defined so as to enable Ethernet and IP Service Capability Negotiation according to the scope of the present invention.

Thus, in one embodiment, if the V-CSN 140 AAA proxy receives the AAA authentication request message 502 from the NAS in the ASN 120, the V-CSN 140 shall attach its own V-CSN Ethernet Service and V-CSN IP Service Capability attributes to the original RADIUS Access Request message sent from the ASN 120. Subsequently, the V-CSN 140 shall forward this message to the H-AAA in the H-CSN 130.

The V-CSN 140 shall attach a V-HA/V-eHA and/or vDHCP (v4 or v6) Server address to the AAA authentication request message 502 and forward this to the H-AAA in the H-CSN 130 if the V-CSN 140 is capable of providing these services. The V-CSN shall not provide an IP Service that is not authorized for in the AAA authentication response message 504. Likewise, the V-CSN 140 shall not provide an Ethernet Service that it is not authorized for in the AAA authentication response message 504. If the V-CSN 140 receives a message which requires it to support an Ethernet Service or an IP service that it cannot support, the V-CSN 140 shall treat the AAA authentication response message 504 as an Access Reject.

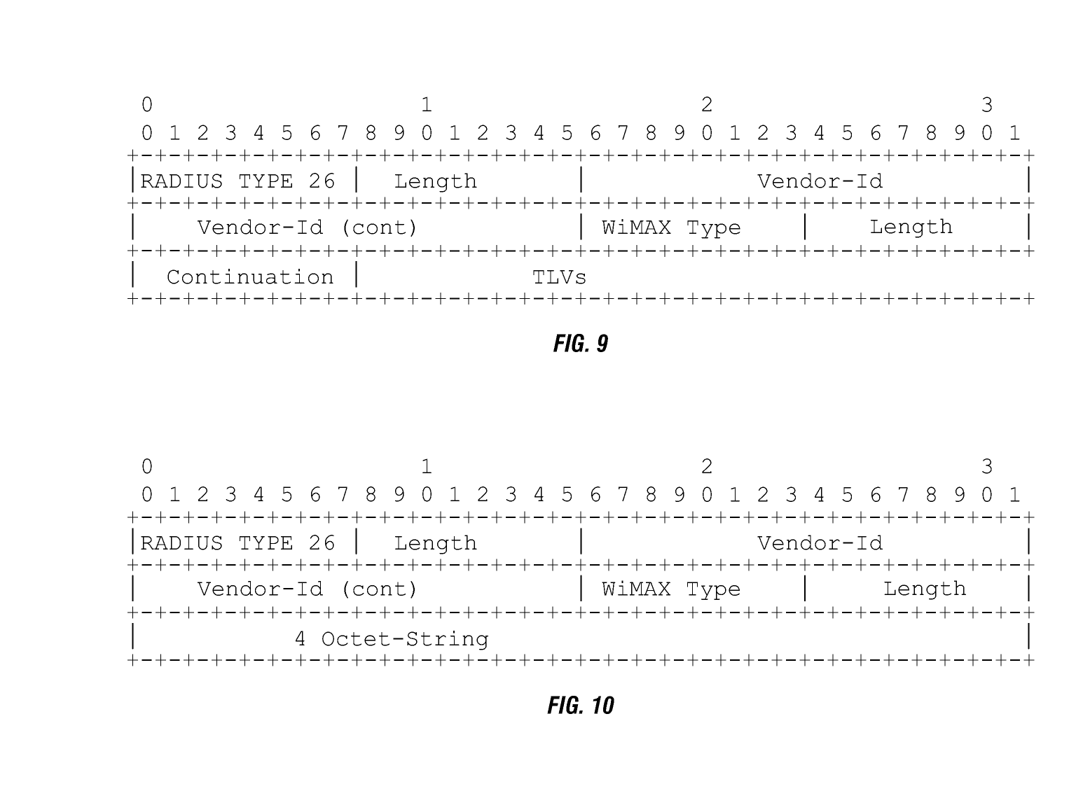

FIGS. 9-22, and the corresponding tables below, illustrate exemplary Type-Length-Value (TLV) definitions for RADIUS Vendor Specific Attributes according to one embodiment of the present invention. Of course, the RADIUS protocol is described here merely for exemplary purposes. It should be understood that a wide range of other protocols may be employed according to the scope of the present invention.

Note that RADIUS Type 26 is depicted throughout FIGS. 9-22. However, other vendor specific attributes may be included, along with varying lengths and vendor-IDs. The vendor specific attributes (e.g., RADIUS Type 26, Length and Vendor-Id), as shown in FIGS. 9-22, may be represented by any common value(s), and are not described in the following tables. Note also that the following tables include specific attributes of WiMAX, such as the WiMAX Type (WType-ID), as well as corresponding lengths and bit mask values. While four octet bit masks are illustrated, other lengths could be utilized according to the scope of the present invention.

FIG. 9 illustrates an exemplary RADIUS TLV definition for indicating WiMAX capability, while Tables 1 and 2 illustrate exemplary ASN 120/V-CSN 140 Ethernet and IP capability type-length-values (TLVs) for an Authorized Ethernet/IP Service definition according to one embodiment of the present invention. Note that the parameters indicated are merely exemplary in nature; the actual parameters may be defined in any number of ways according to the scope of the present invention. For example, in some embodiments, ASN and V-CSN capability may be integrated into a single TLV, using different bits to identify Ethernet capability, IP capability, and/or other service capabilities. In some embodiments, the Authorized Ethernet Service and Authorized Service TLV may be integrated into a single TLV, with different bits identifying different service information.

TABLE 1

| | |
|---|---|
| WType-ID | 1 for WiMAX Capability Attribute |
| Description | In an Access-Request, the attribute identifies the WiMAX |
| | Capabilities supported by the ASN or the HA. In an |
| | Access-Accept, the attribute identifies the options |
| | selected by the RADIUS server. |
| Length | 6 + 3 + TLVs |
| Continuation | C-bit = 0 |
| Value | One or more of the following sub-TLVs (see below) |

TABLE 2

| TLV | | Length | | | | |
|---|---|---|---|---|---|---|
| ID | TLV Name | Octets | AR | AA | AC | R |
| 1 | WiMAX Release | 6 | 1 | 0 | 0 | 0 |
| 2 | Accounting Capabilities | 3 | 1 | 1 | 0 | 0 |
| 3 | Hotlining Capabilities | 3 | 0-1[a] | 0 | 0 | 0 |
| 4 | Idle Mode Notification Capabilities | 3 | 0-1[b] | 0-1[c] | 0 | 0 |
| 5 | ASN IP Service Capabilities | 6 | 1[d], [f] | 0 | 0 | 0 |
| 6 | VCSN IP Service Capabilities | 6 | 0-1[e], [f] | 0 | 0 | 0 |
| 7 | Authorized IP Services | 6 | 0 | 1[f] | 0 | 0 |
| 8 | Authorized Anchor Locations | 3 | 0 | 1[f] | 0 | 0 |
| 9 | ASN Ethernet Service Capabilities | 6 | 1[d], [f] | 0 | 0 | 0 |
| 10 | VCSN Ethernet Service Capabilities | 6 | 0-1[e], [f] | 0 | 0 | 0 |
| 11 | Authorized Ethernet Services | 6 | 0 | 1[f] | 0 | 0 |

Note that in Table 2, the following additional notations [a]-[f] have been provided. Notation [a] indicates that the absence of this sub-TLV in an Access-Request (AR) means that the NAS or HA does not support hotlining. Notation [b] indicates that the absence of this sub-TLV in an Access-Request (AR) means that the NAS does not support Idle Mode notification. This sub-TLV shall not appear in an Access-Request originating from an HA. The H-AAA shall silently ignore this sub-TLV in messages originating from an HA. Notation [c] indicates that the absence of this sub-TLV in an Access-Accept (AA) means that the H-AAA does not require Idle Mode notification. The HAAA shall not send this sub-TLV to an HA. An HA shall silently ignore this sub-TLV. Notation [d] indicates that this sub-TLV is included by the ASN to indicate its supported IP service capabilities. Notation [e] indicates that this sub-TLV should be present when the mobile station attaches through the visited network, included by the V-CSN to indicate its supported IP service capabilities. Notation [f] indicates that this TLV shall not be included for any WiMAX release prior to Release 1.5.

FIG. 10 illustrates an exemplary RADIUS TLV definition which may be used to indicate various ASN and V-CSN service capabilities (e.g., Ethernet and/or IP service capabilities) according to one embodiment of the present invention. Note that a number or code may be identified with the WType-ID (see Table 3 below). For exemplary purposes, however, a “?” is shown throughout the following tables. A person of ordinary skill in the art would recognize that various numbers or codes could be used to represent the WType-ID without departing from the scope of the present disclosure. Table 3 summarizes the exemplary information in a RADIUS message which may be used to indicate ASN IP Service Capability:

TABLE 3

| | |
|---|---|
| WType-ID | ? ASN IP Service Capability |
| Description | This attribute can be included in a RADIUS |
| | Access-Request message to the RADIUS server |
| | and indicates ASN related IP Service |
| | Capabilities |
| Length | 6 + 3 + 4 |
| Continuation | C-bit = 0 |
| Value | 4 octet Bit Mask with the following values: |
| | 0x00000001 = DHCP Relay |
| | 0x00000002 = DHCP Proxy |
| | 0x00000004 = FA |
| | 0x00000008 = PMIP Client |
| | 0x00000010 = MAG with Ipv4 Transport |
| | 0x00000020 = MAG with Ipv6 Transport |
| | 0x00000040 = AR with Ipv4 Transport |
| | 0x00000080 = AR with Ipv6 Transport |
| | The rest bits are reserved |

Table 4 summarizes the exemplary information in a RADIUS message which may be used to indicate ASN Ethernet Service Capability:

TABLE 4

| | |
|---|---|
| WType-ID | ? ASN Ethernet Service Capability |
| Description | This attribute can be included in a RADIUS |
| | Access-Request message to the RADIUS server |
| | and indicates ASN related Ethernet Service |
| | Capabilities |
| Length | 6 + 3 + 4 |
| Continuation | C-bit = 0 |
| Value | 4 octet Bit Mask with the following values: |
| | 0x00000001 = eAFF with IPv4 Transport |
| | 0x00000002 = eAFF with IPv6 Transport |
| | 0x00000004 = eFA |
| | The rest bits are reserved |

Table 5 summarizes the exemplary information in a RADIUS message which may be used to indicate V-CSN IP Service Capability:

TABLE 5

| | |
|---|---|
| WType-ID | ? V-CSN IP Service Capability |
| Description | This attribute can be included in a RADIUS |
| | Access-Request message to the RADIUS server |
| | and indicates V-CSN related IP Service |
| | Capabilities |
| Length | 6 + 3 + 4 |
| Continuation | C-bit = 0 |
| Value | 4 octet Bit Mask with the following values: |
| | 0x00000001 = DHCPv4 Server |
| | 0x00000002 = DHCPv6 Server |
| | 0x00000004 = HAv4 |
| | 0x00000008 = HAv6 |
| | 0x00000010 = LMA with Ipv4 Transport |
| | 0x00000020 = LMA with Ipv6 Transport |
| | 0x00000040 = CR with Ipv4 Transport |
| | 0x00000080 = CR with Ipv6 Transport |
| | The rest bits are reserved |

Table 6 summarizes the exemplary information in a RADIUS message which may be used to indicate V-CSN Ethernet Service Capability:

TABLE 6

| | |
|---|---|
| WType-ID | ? V-CSN Ethernet Service Capability |
| Description | This attribute can be included in a RADIUS |
| | Access-Request message to the RADIUS server |
| | and indicates V-CSN related Ethernet Service |
| | Capabilities |
| Length | 6 + 3 + 4 |
| Continuation | C-bit = 0 |
| Value | 4 octet Bit Mask with the following values: |
| | 0x00000001 = eCFF with Ipv4 transport |
| | 0x00000002 = eCFF with Ipv6 transport |
| | 0x00000004 = eHAv4 |
| | 0x00000008 = eHAv6 |
| | The rest bits are reserved |

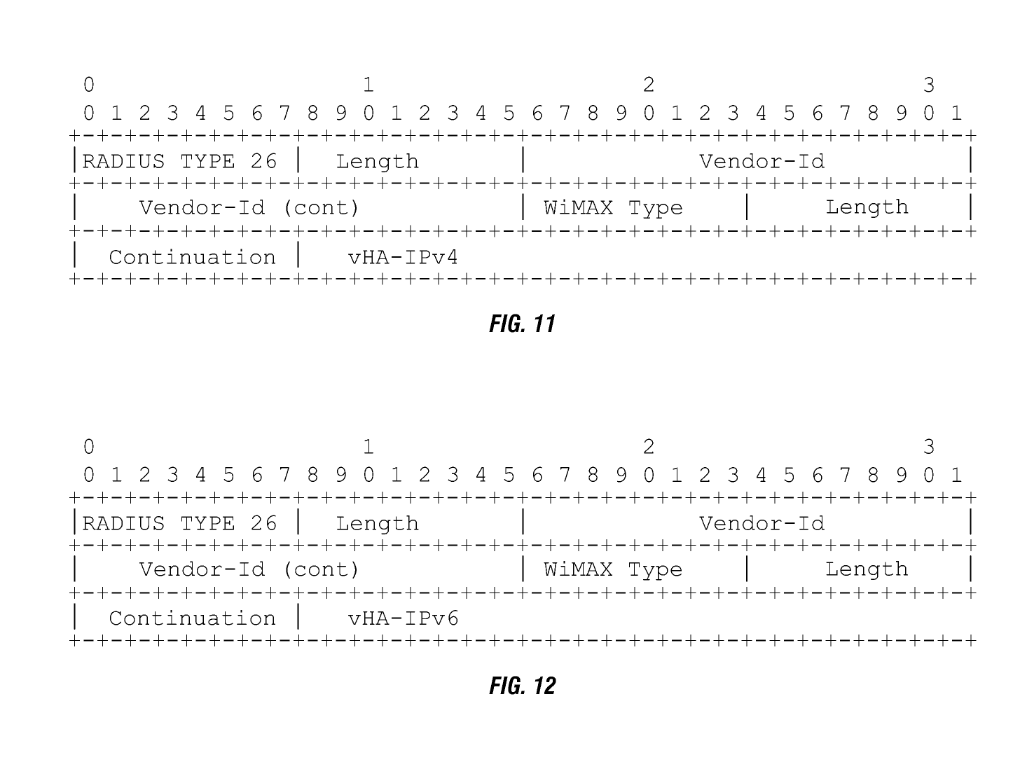

FIGS. 11-22, described below, provide exemplary RADIUS TLVs defining the value(s) of other parameters, such as the IP address of vHA-IPv4, the IP address of vLMA, etc. Note that these TLVs are merely exemplary nature; various other TLVs may be defined without departing from the scope of the present invention.

FIG. 11 illustrates an exemplary RADIUS TLV definition, providing that the ASN and/or the V-CSN 140 IP service capabilities include vHA-IP-MIP4, according to an embodiment of the invention. Of course other information can be included in a RADIUS message. Table 7 summarizes the exemplary information in the RADIUS message of FIG. 11:

TABLE 7

| | |
|---|---|
| WType-ID | ? for vHA-IP-MIP4 |
| Description | The IPv4 address of the V-CSN HA for MIP4. |
| Length | 6 + 3 + 4 |
| Continuation | C-bit = 0 |
| Value | Octet string containing an IPv4 address |
| | (most significant bit first) |

FIG. 12 illustrates an exemplary RADIUS TLV definition, providing that the ASN and/or the V-CSN 140 IP service capabilities include vHA-IP-MIP6, according to an embodiment of the invention. Of course other information can be included in a RADIUS message. Table 8 summarizes the exemplary information in the RADIUS message of FIG. 12:

TABLE 8

| | |
|---|---|
| WType-ID | ? for vHA-IP-MIP6 |
| Description | The IPv6 address of the HA used for MIP6. |
| Length | 6 + 3 + 16 |
| Continuation | C-bit = 0 |
| Value | Octet string containing an IPv6 address |
| | (most significant bit first) |

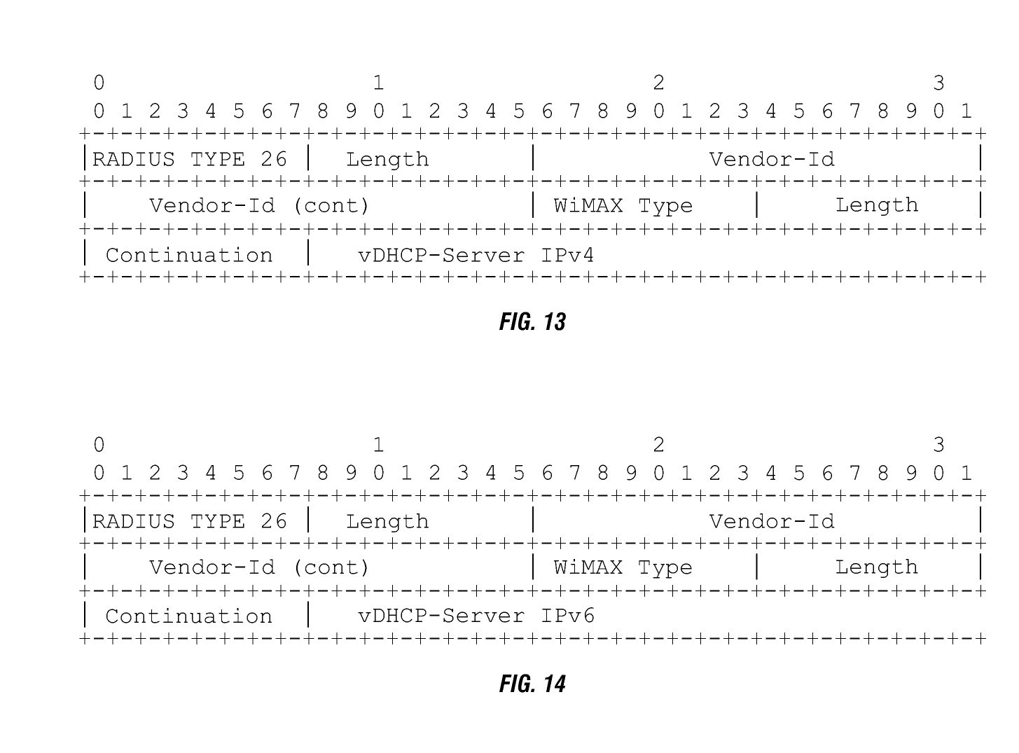

FIG. 13 illustrates an exemplary RADIUS TLV definition, providing the address of a vDHCPv4-Server, according to an embodiment of the invention. Of course other information can be included in a RADIUS message. Table 9 summarizes the exemplary information in the RADIUS message of FIG. 13:

TABLE 9

| | |
|---|---|
| WType-ID | ? for vDHCPv4-Server |
| Description | The IPv4 address of the V-CSN DHCP-Server to use |
| | for IPv4 address allocation |
| Length | 6 + 3 + 4 |
| Continuation | C-bit = 0 |
| Value | Octet string containing an IPv4 address |
| | (most significant bit first). |

FIG. 14 illustrates an exemplary RADIUS TLV definition, providing the IPv6 address of a DHCPv6-Server, according to an embodiment of the invention. Of course other information can be included in a RADIUS message. Table 10 summarizes the exemplary information in the RADIUS message of FIG. 14:

TABLE 10

| | |
|---|---|
| WType-ID | ? for vDHCPv6-Server |
| Description | The IPv6 address of the V-CSN DHCP-Server to use |
| | for IPv6 address allocation |
| Length | 6 + 3 + 16 |
| Continuation | C-bit = 0 |
| Value | Octet string containing an IPv6 address |
| | (most significant bit first) |

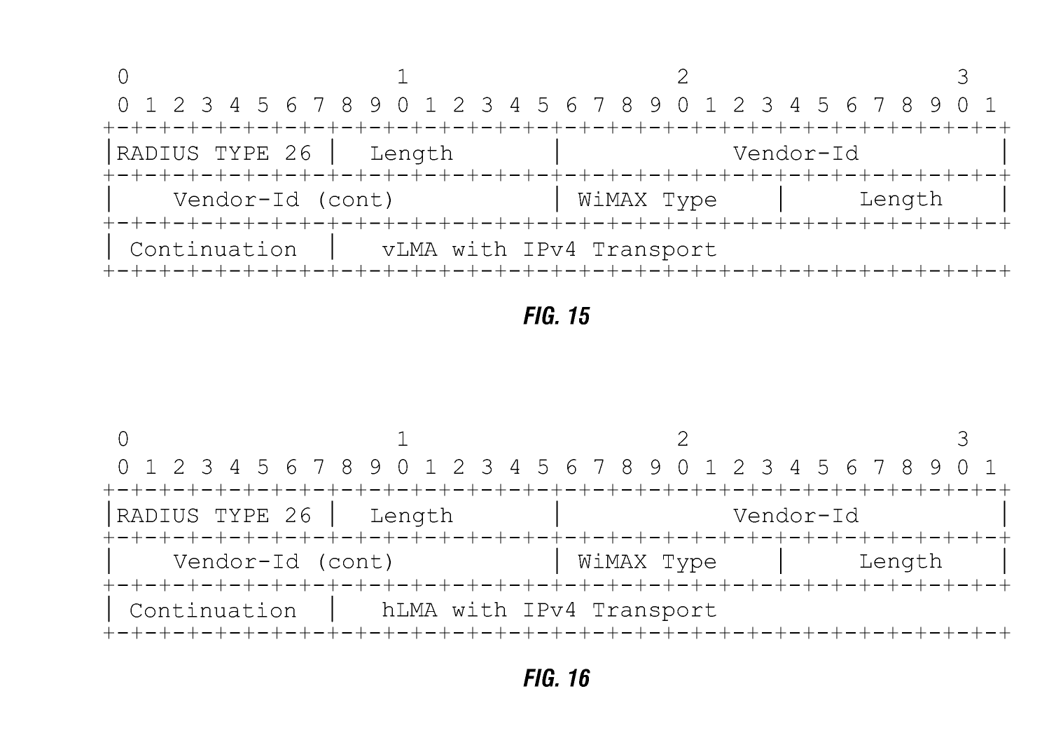

FIG. 15 illustrates an exemplary RADIUS TLV definition, providing the IPv4 address of the V-CSN LMA to use for IPv4 address allocation, according to an embodiment of the invention. Of course other information can be included in a RADIUS message. Table 11 summarizes the exemplary information in the RADIUS message of FIG. 15:

TABLE 11

| | |
|---|---|
| WType-ID | ? for vLMA with IPv4 Transport |
| Description | The IPv4 address of the V-CSN LMA to use |
| | for IPv4 address allocation |
| Length | 6 + 3 + 4 |
| Continuation | C-bit = 0 |
| Value | Octet string containing an IPv4 address |
| | (most significant bit first). |

FIG. 16 illustrates an exemplary RADIUS TLV definition, providing the IPv4 address of the H-CSN LMA to use for IPv4 address allocation, according to an embodiment of the invention. Of course other information can be included in a RADIUS message. Table 12 summarizes the exemplary information in the RADIUS message of FIG. 16:

TABLE 12

| | |
|---|---|
| WType-ID | ? for hLMA with IPv4 Transport |
| Description | The IPv4 address of the H-CSN LMA to use |
| | for IPv4 address allocation |
| Length | 6 + 3 + 4 |
| Continuation | C-bit = 0 |
| Value | Octet string containing an IPv4 address |
| | (most significant bit first). |

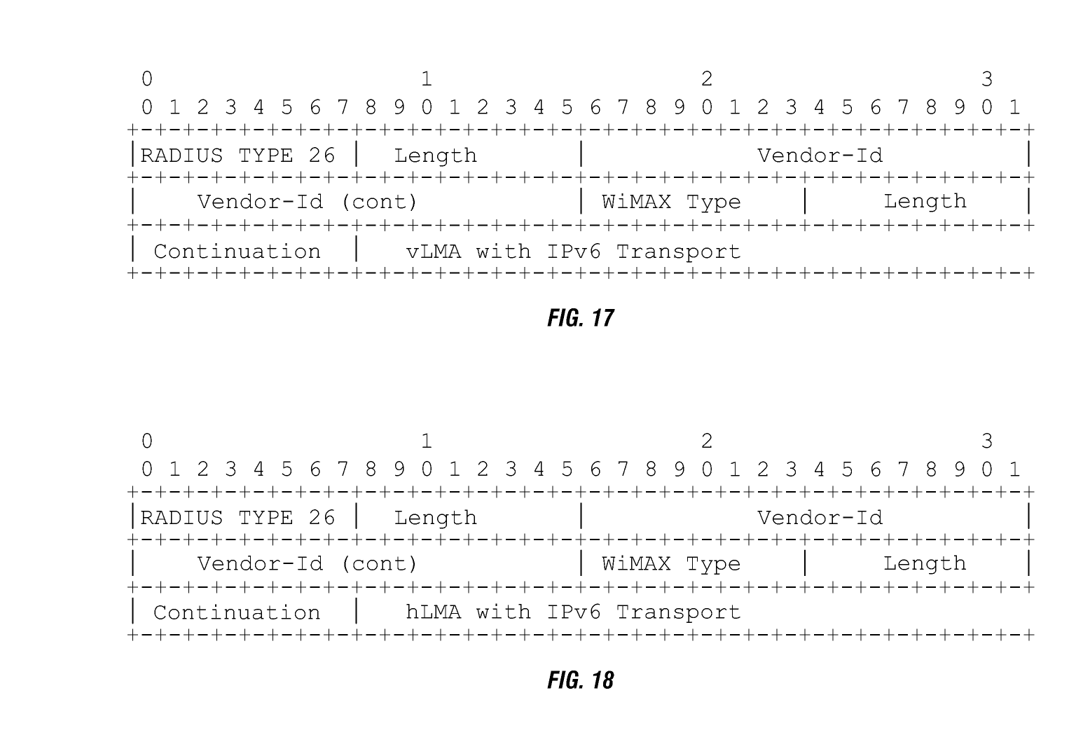

FIG. 17 illustrates an exemplary RADIUS TLV definition, providing the IPv6 address of the V-CSN LMA to use for IPv6 address allocation, according to an embodiment of the invention. Of course other information can be included in a RADIUS message. Table 13 summarizes the exemplary information in the RADIUS message of FIG. 17:

TABLE 13

| | |
|---|---|
| WType-ID | ? for vLMA with IPv6 Transport |
| Description | The IPv4 address of the V-CSN LMA to use |
| | for IPv6 address allocation |
| Length | 6 + 3 + 16 |
| Continuation | C-bit = 0 |
| Value | Octet string containing an IPv6 address |
| | (most significant bit first). |

FIG. 18 illustrates an exemplary RADIUS TLV definition, providing the IPv6 address of the H-CSN hLMA to use for IPv6 address allocation, according to an embodiment of the invention. Of course other information can be included in a RADIUS message. Table 14 summarizes the exemplary information in the RADIUS message of FIG. 18:

TABLE 14

| | |
|---|---|
| WType-ID | ? for hLMA with IPv6 Transport |
| Description | The IPv4 address of the H-CSN LMA to use |
| | for IPv6 address allocation |
| Length | 6 + 3 + 16 |
| Continuation | C-bit = 0 |
| Value | Octet string containing an IPv6 address |
| | (most significant bit first). |

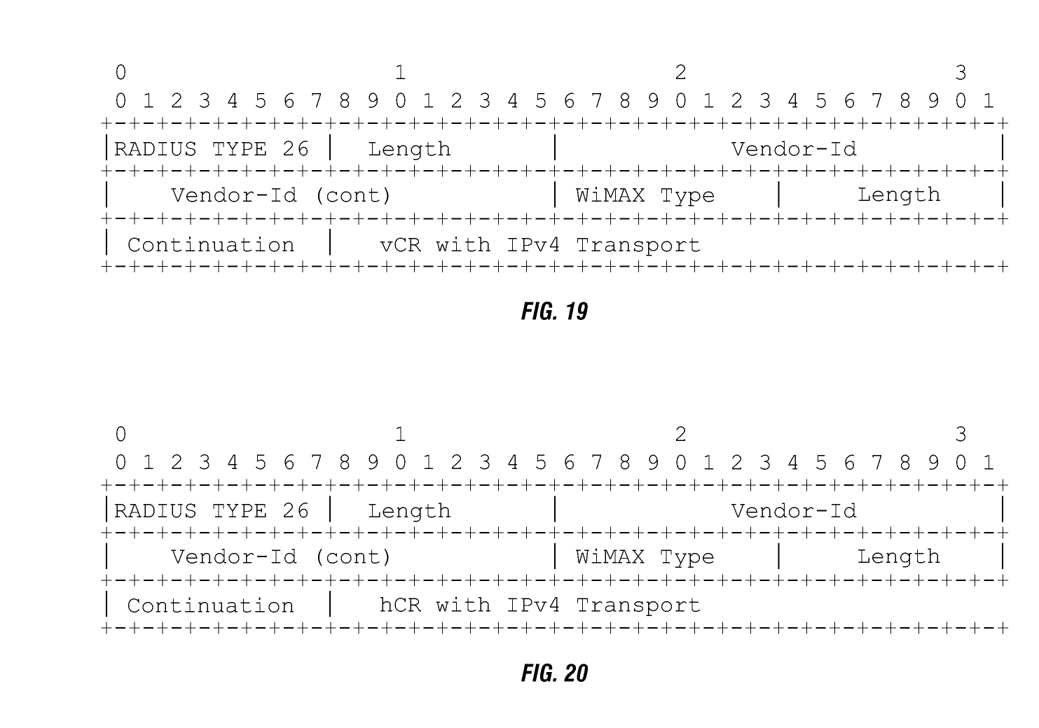

FIG. 19 illustrates an exemplary RADIUS TLV definition, providing the IPv4 address of the V-CSN CR to use for IPv4 address allocation, according to an embodiment of the invention. Of course other information can be included in a RADIUS message. Table 15 summarizes the exemplary information in the RADIUS message of FIG. 19:

TABLE 15

| | |
|---|---|
| WType-ID | ? for vCR with IPv4 Transport |
| Description | The IPv4 address of the V-CSN CR to use |
| | for IPv4 address allocation |
| Length | 6 + 3 + 4 |
| Continuation | C-bit = 0 |
| Value | Octet string containing an IPv4 address |
| | (most significant bit first). |

FIG. 20 illustrates an exemplary RADIUS TLV definition, providing the IPv4 address of the H-CSN CR to use for IPv4 address allocation, according to an embodiment of the invention. Of course other information can be included in a RADIUS message. Table 16 summarizes the exemplary information in the RADIUS message of FIG. 20:

TABLE 16

| | |
|---|---|
| WType-ID | ? for hCR with IPv4 Transport |
| Description | The IPv4 address of the H-CSN CR to use |
| | for IPv4 address allocation |
| Length | 6 + 3 + 4 |
| Continuation | C-bit = 0 |
| Value | Octet string containing an IPv4 address |
| | (most significant bit first). |

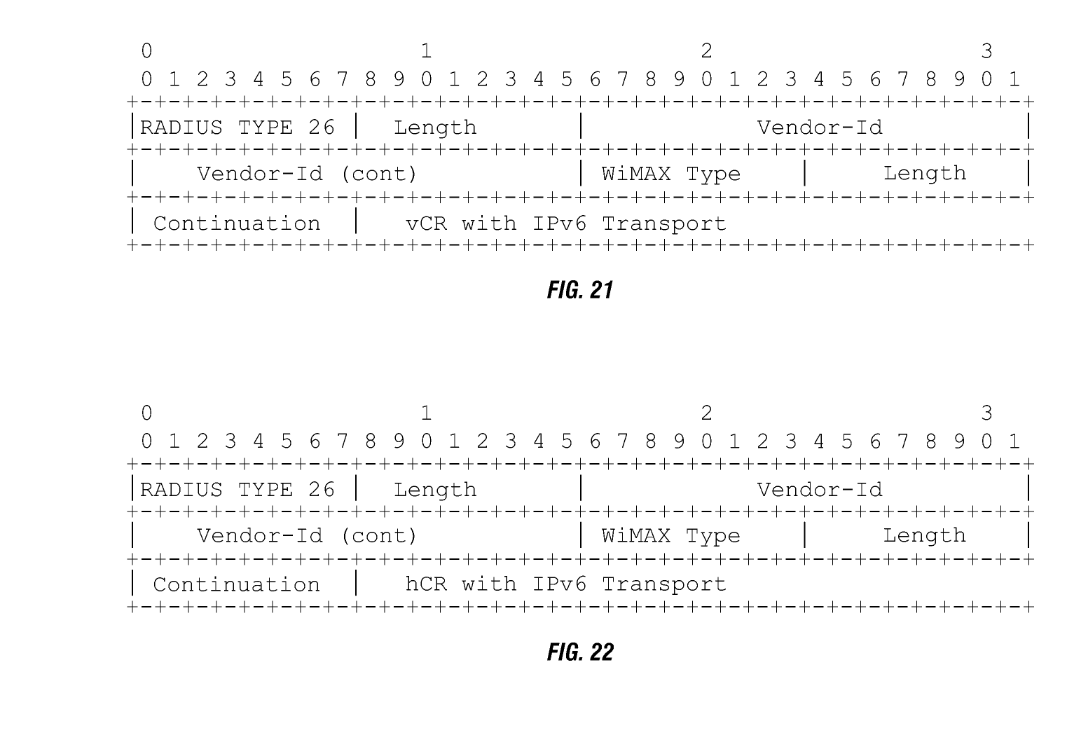

FIG. 21 illustrates an exemplary RADIUS TLV definition, providing the IPv6 address of the V-CSN CR to use for IPv6 address allocation, according to an embodiment of the invention. Of course other information can be included in a RADIUS message. Table 17 summarizes the exemplary information in the RADIUS message of FIG. 21:

TABLE 17

| | |
|---|---|
| WType-ID | ? for vCR with IPv6 Transport |
| Description | The IPv4 address of the V-CSN CR to use |
| | for IPv6 address allocation |
| Length | 6 + 3 + 16 |
| Continuation | C-bit = 0 |
| Value | Octet string containing an IPv6 address |
| | (most significant bit first). |

FIG. 22 illustrates an exemplary RADIUS TLV definition, providing the IPv6 address of the H-CSN CR to use for IPv6 address allocation, according to an embodiment of the invention. Of course other information can be included in a RADIUS message. Table 18 summarizes the exemplary information in the RADIUS message of FIG. 22:

TABLE 18

| | |
|---|---|
| WType-ID | ? for hCR with IPv6 Transport |
| Description | The IPv4 address of the H-CSN CR to use |
| | for IPv6 address allocation |
| Length | 6 + 3 + 16 |
| Continuation | C-bit = 0 |
| Value | Octet string containing an IPv6 address |
| | (most significant bit first). |

Additionally, Table 19 summarizes exemplary information for a TLV indicating Authorized IP Services, while Table 20 summarizes exemplary information for a TLV indicating Authorized Ethernet Services.

TABLE 19

| | |
|---|---|
| TLV-ID | 7 for Authorized IP Services |
| Description | This TLV is included in a RADIUS Access-Accept message |
| | to the NAS and indicates related IP Service Capabilities |
| | the ASN is authorized to Support |
| Length | 2 + 4 octet |
| Value | 4 octet Bit Mask with the following values: |
| | 0x00000001 = CMIP4 |
| | 0x00000002 = PMIP4 |
| | 0x00000004 = Simple Ipv4 |
| | 0x00000008 = CMIP6 |
| | 0x00000010 = PMIP6 |
| | 0x00000020 = Simple IPv6 |
| | The rest bits are reserved |

TABLE 20

| | |
|---|---|
| TLV-ID | 7 for Authorized Ethernet Services |
| Description | This TLV is used to indicate related Ethernet Service |
| | Capabilities the ASN is authorized to support |
| Length | 2 + 4 octet |
| Value | 4 octet Bit Mask with the following values: |
| | 0x00000001 = Simple Ethernet Service |
| | 0x00000002 = MIP Ethernet Service |
| | The rest bits are reserved |

Tables 21 and 22 illustrate exemplary ASN 120/V-CSN 140 Ethernet and IP capability type-length-values (TLVs) for an Authorized Ethernet/IP Service definition according to another embodiment of the present invention. Note that the parameters indicated below are merely exemplary in nature; the actual parameters may be defined in any number of ways according to the scope of the present invention. For example, in some embodiments, ASN and V-CSN capability may be integrated into a single TLV, using different bits to identify Ethernet capability, IP capability, and/or other service capabilities. In some embodiments, the Authorized Ethernet Service and Authorized Service TLV may be integrated into a single TLV, with different bits identifying different service information.

TABLE 21

| | |
|---|---|
| WType-ID | 1 for WiMAX Capability Attribute |
| Description | In an Access-Request, the attribute identifies the |
| | WiMAX Capabilities supported by the ASN or the HA. |
| | In an Access-Accept, the attribute identifies |
| | the options selected by the RADIUS server. |
| Length | 6 + 3 + TLVs |
| Continuation | C-bit = 0 |
| Value | One or more of the following sub-TLVs (see below) |

TABLE 22

| TLV | | Length | | | | |
|---|---|---|---|---|---|---|
| ID | TLV Name | Octets | AR | AA | AC | R |
| 1 | WiMAX Release | 6 | 1 | 0 | 0 | 0 |
| 2 | Accounting Capabilities | 3 | 1 | 1 | 0 | 0 |
| 3 | Hotlining Capabilities | 3 | 0-1[a] | 0 | 0 | 0 |
| 4 | Idle Mode Notification Capabilities | 3 | 0-1[b] | 0-1[c] | 0 | 0 |
| 5 | ASN Service Capabilities | 6 | 1[d], [f] | 0 | 0 | 0 |
| 6 | VCSN Service Capabilities | 6 | 0-1[e], [f] | 0 | 0 | 0 |
| 7 | Authorized Services | 6 | 0 | 1[f] | 0 | 0 |
| 8 | Authorized Anchor Locations | 3 | 0 | 1[f] | 0 | 0 |

Note that in Table 22, the following additional notations [a]-[f] have been provided. Notation [a] indicates that the absence of this sub-TLV in an Access-Request (AR) means that the NAS or HA does not support hotlining. Notation [b] indicates that the absence of this sub-TLV in an Access-Request (AR) means that the NAS does not support Idle Mode notification. This sub-TLV shall not appear in an Access-Request originating from an HA. The H-AAA shall silently ignore this sub-TLV in messages originating from an HA. Notation [c] indicates that the absence of this sub-TLV in an Access-Accept (AA) means that the H-AAA does not require Idle Mode notification. The HAAA shall not send this sub-TLV to an HA. An HA shall silently ignore this sub-TLV. Notation [d] indicates that this sub-TLV is included by the ASN to indicate its supported service capabilities, including IP service, Ethernet service, etc. Notation [e] indicates that this sub-TLV should be present when the mobile station attaches through the visited network, included by the V-CSN to indicate its supported service capabilities, i.e., IP, Ethernet, etc. Notation [f] indicates that this TLV shall not be included for any WiMAX release prior to Release 1.5.

Table 23 summarizes the exemplary information in a RADIUS message which may be used to indicate ASN Service Capability (e.g., Ethernet, IP, or other service) according to one embodiment of the present invention. Note that an exemplary RADIUS TLV definition which may be used to indicate the ASN service capabilities has been already shown in FIG. 10.

TABLE 23

| | |
|---|---|
| WType-ID | ? ASN Service Capability |
| Description | This attribute can be included in a RADIUS |
| | Access-Request message to the RADIUS server |
| | and indicates ASN related Service |
| | Capabilities, i.e., IP, Ethernet, or |
| | future applicable services |
| Length | 6 + 3 + 4 |
| Continuation | C-bit = 0 |
| Value | 4 octet Bit Mask with the following values: |
| | 0x00000001 = DHCP Relay |
| | 0x00000002 = DHCP Proxy |
| | 0x00000004 = FA |
| | 0x00000008 = PMIP Client |
| | 0x00000010 = MAG with Ipv4 Transport |
| | 0x00000020 = MAG with Ipv6 Transport |
| | 0x00000040 = AR with Ipv4 Transport |
| | 0x00000080 = AR with Ipv6 Transport |
| | 0x00000100 = eAFF with Ipv4 Transport |
| | 0x00000200 = eAFF with Ipv6 Transport |
| | 0x00000400 = eFA |
| | The rest bits are reserved |

Table 24 summarizes the exemplary information in a RADIUS message which may be used to indicate V-CSN Service Capability (e.g., Ethernet, IP, or other service) according to one embodiment of the present invention. Note that an exemplary RADIUS TLV definition which may be used to indicate the V-CSN service capabilities has been already shown in FIG. 10.

TABLE 24

| | |
|---|---|
| WType-ID | ? V-CSN Service Capability |
| Description | This attribute can be included in a RADIUS |
| | Access-Request message to the RADIUS server |
| | and indicates V-CSN related Service |
| | Capabilities, i.e. IP, Ethernet, etc. |
| Length | 6 + 3 + 4 |
| Continuation | C-bit = 0 |
| Value | 4 octet Bit Mask with the following values: |
| | 0x00000001 = DHCPv4 Server |
| | 0x00000002 = DHCPv6 Server |
| | 0x00000004 = HAv4 |
| | 0x00000008 = HAv6 |
| | 0x00000010 = LMA with Ipv4 Transport |
| | 0x00000020 = LMA with Ipv6 Transport |
| | 0x00000040 = CR with Ipv4 Transport |
| | 0x00000080 = CR with Ipv6 Transport |
| | 0x00000100 = eCFF with Ipv4 Transport |
| | 0x00000200 = eCFF with Ipv6 Transport |
| | 0x00000400 = eHAv4 |
| | 0x00000800 = eHAv6 |
| | The rest bits are reserved |

Table 25 summarizes the exemplary information in a RADIUS message which may be used to indicate the IPv4 address of a V-CSN HA for MIP4 according to one embodiment of the present invention. Note that an exemplary RADIUS TLV definition which may be used to indicate the vHA-IP-MIP4 has been already shown in FIG. 11.

TABLE 25

| | |
|---|---|
| WType-ID | ? for vHA-IP-MIP4 |
| Description | The IPv4 address of the V-CSN HA for MIP4. |
| Length | 6 + 3 + 4 |
| Continuation | C-bit = 0 |
| Value | Octet string containing an IPv4 address |
| | (most significant bit first) |

Table 26 summarizes the exemplary information in a RADIUS message which may be used to indicate the IPv6 address of an HA for MIP6 according to one embodiment of the present invention. Note that an exemplary RADIUS TLV definition which may be used to indicate the vHA-IP-MIP6 has been already shown in FIG. 12.

TABLE 26

| | |
|---|---|
| WType-ID | ? for vHA-IP-MIP6 |
| Description | The IPv6 address of the HA used for MIP6. |
| Length | 6 + 3 + 16 |
| Continuation | C-bit = 0 |
| Value | Octet string containing an IPv6 address |
| | (most significant bit first) |

Table 27 summarizes the exemplary information in a RADIUS message which may be used to indicate the IPv4 address of the V-CSN DHCP-Server for IPv4 address allocation according to one embodiment of the present invention. Note that an exemplary RADIUS TLV definition which may be used to indicate the vDHCPv4-Server has been already shown in FIG. 13.

TABLE 27

| | |
|---|---|
| WType-ID | ? for vDHCPv4-Server |
| Description | The IPv4 address of the V-CSN DHCP-Server to use |
| | for IPv4 address allocation |
| Length | 6 + 3 + 4 |
| Continuation | C-bit = 0 |
| Value | Octet string containing an IPv4 address |
| | (most significant bit first). |

Table 28 summarizes the exemplary information in a RADIUS message which may be used to indicate the IPv6 address of the DHCP-Server for IPv6 address allocation according to one embodiment of the present invention. Note that an exemplary RADIUS TLV definition which may be used to indicate the vDHCPv6-Server has been already shown in FIG. 14.

TABLE 28

| | |
|---|---|
| WType-ID | ? for vDHCPv6-Server |
| Description | The IPv6 address of the V-CSN DHCP-Server to use |
| | for IPv6 address allocation |
| Length | 6 + 3 + 16 |
| Continuation | C-bit = 0 |
| Value | Octet string containing an IPv6 address |
| | (most significant bit first) |

Table 29 summarizes the exemplary information in a RADIUS message which may be used to indicate the IPv4 address of the V-CSN LMA for IPv4 address allocation according to one embodiment of the present invention. Note that an exemplary RADIUS TLV definition which may be used to indicate vLMA with IPv4 Transport has been already shown in FIG. 15.

TABLE 29

| | |
|---|---|
| WType-ID | ? for vLMA with IPv4 Transport |
| Description | The IPv4 address of the V-CSN LMA to use |
| | for IPv4 address allocation |
| Length | 6 + 3 + 4 |
| Continuation | C-bit = 0 |
| Value | Octet string containing an IPv4 address |
| | (most significant bit first). |

Table 30 summarizes the exemplary information in a RADIUS message which may be used to indicate the IPv4 address of the H-CSN LMA for IPv4 address allocation according to one embodiment of the present invention. Note that an exemplary RADIUS TLV definition which may be used to indicate hLMA with IPv4 Transport has been already shown in FIG. 16.

TABLE 30

| | |
|---|---|
| WType-ID | ? for hLMA with IPv4 Transport |
| Description | The IPv4 address of the H-CSN LMA to use |
| | for IPv4 address allocation |
| Length | 6 + 3 + 4 |
| Continuation | C-bit = 0 |
| Value | Octet string containing an IPv4 address |
| | (most significant bit first). |

Table 31 summarizes the exemplary information in a RADIUS message which may be used to indicate the IPv4 address of the V-CSN LMA for IPv6 address allocation according to one embodiment of the present invention. Note that an exemplary RADIUS TLV definition which may be used to indicate vLMA with IPv6 Transport has been already shown in FIG. 17.

TABLE 31

| | |
|---|---|
| WType-ID | ? for vLMA with IPv6 Transport |
| Description | The IPv4 address of the V-CSN LMA to use |
| | for IPv6 address allocation |
| Length | 6 + 3 + 16 |
| Continuation | C-bit = 0 |
| Value | Octet string containing an IPv6 address |
| | (most significant bit first). |

Table 32 summarizes the exemplary information in a RADIUS message which may be used to indicate the IPv4 address of the H-CSN LMA for IPv6 address allocation according to one embodiment of the present invention. Note that an exemplary RADIUS TLV definition which may be used to indicate hLMA with IPv6 Transport has been already shown in FIG. 18.

TABLE 32

| | |
|---|---|
| WType-ID | ? for hLMA with IPv6 Transport |
| Description | The IPv4 address of the H-CSN LMA to use |
| | for IPv6 address allocation |
| Length | 6 + 3 + 16 |
| Continuation | C-bit = 0 |
| Value | Octet string containing an IPv6 address |
| | (most significant bit first). |

Table 33 summarizes the exemplary information in a RADIUS message which may be used to indicate the IPv4 address of the V-CSN CR for IPv4 address allocation according to one embodiment of the present invention. Note that an exemplary RADIUS TLV definition which may be used to indicate vCR with IPv4 Transport has been already shown in FIG. 19.

TABLE 33

| | |
|---|---|
| WType-ID | ? for vCR with IPv4 Transport |
| Description | The IPv4 address of the V-CSN CR to use |
| | for IPv4 address allocation |
| Length | 6 + 3 + 4 |
| Continuation | C-bit = 0 |
| Value | Octet string containing an IPv4 address |
| | (most significant bit first). |

Table 34 summarizes the exemplary information in a RADIUS message which may be used to indicate the IPv4 address of the H-CSN CR for IPv4 address allocation according to one embodiment of the present invention. Note that an exemplary RADIUS TLV definition which may be used to indicate hCR with IPv4 Transport has been already shown in FIG. 20.

TABLE 34

| | |
|---|---|
| WType-ID | ? for hCR with IPv4 Transport |
| Description | The IPv4 address of the H-CSN CR to use |
| | for IPv4 address allocation |
| Length | 6 + 3 + 4 |
| Continuation | C-bit = 0 |
| Value | Octet string containing an IPv4 address |
| | (most significant bit first). |

Table 35 summarizes the exemplary information in a RADIUS message which may be used to indicate the IPv4 address of the V-CSN CR for IPv6 address allocation according to one embodiment of the present invention. Note that an exemplary RADIUS TLV definition which may be used to indicate vCR with IPv6 Transport has been already shown in FIG. 21.

TABLE 35

| | |
|---|---|
| WType-ID | ? for vCR with IPv6 Transport |
| Description | The IPv4 address of the V-CSN CR to use |
| | for IPv6 address allocation |
| Length | 6 + 3 + 16 |
| Continuation | C-bit = 0 |
| Value | Octet string containing an IPv6 address |
| | (most significant bit first). |

Table 36 summarizes the exemplary information in a RADIUS message which may be used to indicate the IPv4 address of the H-CSN CR for IPv6 address allocation according to one embodiment of the present invention. Note that an exemplary RADIUS TLV definition which may be used to indicate hCR with IPv6 Transport has been already shown in FIG. 22.

TABLE 36

| | |
|---|---|
| WType-ID | ? for hCR with IPv6 Transport |
| Description | The IPv4 address of the H-CSN CR to use |
| | for IPv6 address allocation |
| Length | 6 + 3 + 16 |
| Continuation | C-bit = 0 |
| Value | Octet string containing an IPv6 address |
| | (most significant bit first). |

Additionally, Table 37 summarizes exemplary information for a TLV indicating Authorized Services.

TABLE 37

| | |
|---|---|
| TLV-ID | 7 for Authorized Services |
| Description | This TLV is included in a RADIUS Access-Accept message |
| | to the NAS and indicates related Service |
| | Capabilities (i.e., IP, Ethernet, etc.) that the ASN |
| | is authorized to Support |
| Length | 2 + 4 octet |
| Value | 4 octet Bit Mask with the following values: |
| | 0x00000001 = CMIP4 |
| | 0x00000002 = PMIP4 |
| | 0x00000004 = Simple IPv4 |
| | 0x00000008 = CMIP6 |
| | 0x00000010 = PMIP6 |
| | 0x00000020 = Simple IPv6 |
| | 0x00000040 = Simple Ethernet Service |
| | 0x00000080 = MIP Ethernet Service |
| | The rest bits are reserved |

Thus, various methods and systems described herein provide for Ethernet and/or IP service capability negotiation and authorization among different network entities. In addition, embodiments of the present invention are capable of leveraging the network access authentication and authorization process to negotiate the appropriate Ethernet and/or IP service among various network entities using remote authentication protocols.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of negotiating and authorizing one or more Ethernet services among a plurality of network entities in a wireless communication system, the method comprising:
transmitting a first signal from a first network device to a second network device, the first signal adapted to indicate Ethernet service capability data associated with the first network device;
receiving at the first network device a second signal from the second network device, the second signal adapted to indicate a set of authorized Ethernet services for a mobile station adapted for communication with the first network device; and
storing data at the first network device, wherein the data is adapted to indicate the set of authorized Ethernet services for the mobile station.

2. The method of claim 1, wherein the wireless communication system comprises a WiMAX communication system.

3. The method of claim 1, wherein the first signal is further adapted to indicate IP service capability data associated with the first network device, wherein the second signal is further adapted to indicate a set of authorized IP services for the mobile station, and wherein the data is further adapted to indicate the set of authorized IP services for the mobile station.

4. The method of claim 1, wherein the first signal comprises an AAA authentication request message.

5. The method of claim 1, wherein the first network device comprises an access service network entity.

6. The method of claim 5, wherein the first signal comprises at least one RADIUS attribute adapted to indicate Ethernet Service Capability of the access service network entity.

7. The method of claim 1, wherein the second network device comprises a visited connectivity service network entity.

8. The method of claim 1, wherein the second network device comprises a home connectivity service network entity.

9. The method of claim 1, wherein the second signal comprises an AAA authentication response message.

10. The method of claim 1 further comprising:
receiving a third signal at the first network device, the third signal transmitted from the mobile station and adapted to indicate a requested Ethernet service; and
determining at the first network device whether the set of authorized Ethernet services includes the requested Ethernet service.

11. A method of negotiating and authorizing one or more Ethernet services among a plurality of network entities in a wireless communication system, the method comprising:
receiving at a second network device a first signal from a first network device, the first signal adapted to indicate Ethernet service capability data associated with the first network device;
determining a set of authorized Ethernet services for a mobile station adapted for communication with the first network device based at least in part upon the Ethernet service capability data; and
transmitting a second signal from the second network device to the first network device, the second signal adapted to indicate the set of authorized Ethernet services for the mobile station.

12. The method of claim 11, wherein the wireless communication system comprises a WiMAX communication system.

13. The method of claim 11, wherein the first signal is further adapted to indicate IP service capability data associated with the first network device, wherein said determining a set of authorized Ethernet services for a mobile station further comprises determining a set of authorized IP services for the mobile station, and wherein the second signal is further adapted to indicate the set of authorized IP services for the mobile station.

14. The method of claim 11, wherein the first signal comprises an AAA authentication request message.

15. The method of claim 1, wherein the first network device comprises an access service network entity.

16. The method of claim 15, wherein the first network device comprises a visited connectivity service network entity.

17. The method of claim 11, wherein said determining a set of authorized Ethernet services for a mobile station is based at least in part upon a subscriber profile associated with the mobile station.

18. The method of claim 11, wherein said determining a set of authorized Ethernet services for a mobile station is based at least in part upon a home network policy.

19. The method of claim 11, wherein the second network device comprises a home connectivity service network entity.

20. The method of claim 1, wherein the second signal comprises an AAA authentication response message.

21. A method of negotiating and authorizing one or more Ethernet services among a plurality of network entities in a wireless communication system, the method comprising:
receiving at an intermediary network device a set of capability data, the set of capability data adapted to indicate Ethernet capability data associated with a first network device;
appending Ethernet capability data associated with the intermediary network device to the set of capability data;
transmitting the set of capability data to a second network device, the second network device adapted to generate a set of authorization data for indicating a set of authorized Ethernet services for a mobile station in communication with the first network device, wherein the set of authorization data is based at least in part upon the set of capability data;
receiving at the intermediary network device the set of authorization data; and
transmitting the set of authorization data to the first network device, wherein the first network device is adapted to provide Ethernet service to the mobile station based at least in part upon the set of authorization data.

22. The method of claim 21, wherein the wireless communication system comprises a WiMAX communication system.

23. The method of claim 21, wherein the set of capability data received at the intermediary network device is further adapted to indicate IP service capability data associated with the first network device, wherein said appending Ethernet capability data associated with the intermediary network device further comprises appending IP capability data associated with the intermediary network device, wherein the authorization data is further adapted to indicate a set of authorized IP services for the mobile station, and wherein the first network device is further adapted to provide Ethernet service to the mobile station based at least in part upon the set of authorization data.

24. The method of claim 21, wherein the first network device comprises an access service network entity.

25. The method of claim 21, wherein the intermediary network device comprises a visited connectivity service network entity.

26. The method of claim 21, wherein the second network device comprises a home connectivity service network entity.

27. A system for negotiating and authorizing one or more Ethernet services among a plurality of network entities in a wireless communication system, the system comprising:
means for transmitting a first signal from a first network device to a second network device, the first signal adapted to indicate Ethernet service capability data associated with the first network device;
means for receiving at the first network device a second signal from the second network device, the second signal adapted to indicate a set of authorized Ethernet services for a mobile station adapted for communication with the first network device; and
means for storing data at the first network device, wherein the data is adapted to indicate the set of authorized Ethernet services for the mobile station.

28. The system of claim 27, wherein the wireless communication system comprises a WiMAX communication system.

29. The system of claim 27, wherein the first signal is further adapted to indicate IP service capability data associated with the first network device, wherein the second signal is further adapted to indicate a set of authorized IP services for the mobile station, and wherein the data is further adapted to indicate the set of authorized IP services for the mobile station.

30. The system of claim 27, wherein the first signal comprises an AAA authentication request message.

31. The system of claim 27, wherein the first network device comprises an access service network entity.

32. The system of claim 31, wherein the first signal comprises at least one RADIUS attribute adapted to indicate Ethernet Service Capability of the access service network entity.

33. The system of claim 27, wherein the second network device comprises a visited connectivity service network entity.

34. The system of claim 27, wherein the second network device comprises a home connectivity service network entity.

35. The system of claim 27, wherein the second signal comprises an AAA authentication response message.
